(19) United States
(12) Patent Application Publication
(10) Pub. No.: US 2020/0371881 A1
(43) Pub. Date: Nov. 26, 2020

(54) DATA READING METHOD OF DATA SOURCE SYSTEM HAVING DUPLICATE DATA SOURCES

(71) Applicant: QNAP SYSTEMS, INC., New Taipei City (TW)

(72) Inventor: MING CHUN HSIA, NEW TAIPEI CITY (TW)

(21) Appl. No.: 16/879,141

(22) Filed: May 20, 2020

(30) Foreign Application Priority Data
May 24, 2019 (TW) 108118092

(51) Int. Cl. G06F 11/14; G06F 16/174

(52) U.S. Cl. CPC G06F 11/1464; G06F 11/1451; G06F 16/1748; G06F 11/1461; G06F 11/1456

(57) ABSTRACT

A data reading method of a data source system having duplicate data sources is provided. The data source system stores specified data in a primary data server and at least one backup data server. In the data reading method, a client terminal can read the specified data from any one of the primary data server and the at least one backup data server, but not only the primary data server, according to the access superiority of the data servers.

### FIELD OF THE INVENTION

The present disclosure relates to a data reading method of a consolidated data source, and particularly to a data reading method of a data source system having duplicate data sources.

### BACKGROUND OF THE INVENTION

The consolidated data source system, e.g. hyper-converged infrastructure (HCI), is a system which consolidates machines to provide a virtual file server center. In the system, a plurality of machines having respective storage devices are integrated together. These machines are managed by a control center such as a hypervisor to provide data storage and access services for external devices. The market of the consolidated data source system is increasing because complex hardware scheduling is not needed and it simplifies the management of the system.

To guarantee security of stored data, most consolidated data source systems put received original data in one machine, and further makes and stores at least one backup of the original data in one or more machines. When a client terminal requests to access the data, the control center informs the client terminal with the machine which stores the original data, and the client terminal can access the original data from the designated machine.

While arranging the machines for storing the original data and the backup data, the control center usually considers the load average of all machines. However, the conventional control center does not observe that the client terminal is not always located in a fixed position, and the client terminal is even located at a considerable distance from the designated machine storing the original data. The data transmission across the considerable distance usually causes long access time and low access efficiency.

### SUMMARY OF THE INVENTION

An aspect of the present disclosure provides a data reading method of a data source system having duplicate data sources. The data source system includes m data servers wherein m is a positive integer, and each data server corresponds to a service area. The data source system stores specified data by storing a primary copy of the specified data in a primary data server of the m data servers and storing a backup copy of the specified data in each of at least one backup data server of the m data servers other than the primary data server. The data reading method includes steps of: receiving a data reading request of the specified data from a client terminal; obtaining a superiority parameter related to each of the primary data server and the at least one backup data server; providing a candidate data server list according to the obtained superiority parameters wherein the candidate data server list records at least one of the primary data server and the at least one backup data server; and the client terminal receiving the candidate data server list and reading the specified data from the primary data server or the at least one backup data server recorded in the candidate data server list.

In an embodiment, the steps of obtaining the superiority parameters and providing the candidate data server list according to the obtained superiority parameters includes steps of: judging whether the client terminal is positioned within a service area of any one of the at least one backup data server; when the client terminal is positioned within the service area of one of the at least one backup data server, adding the one backup data server to the candidate data server list; and when the client terminal is not positioned within the service area of any one of the at least one backup data server, adding the primary data server to the candidate data server list.

In an embodiment, the candidate data server list is determined according to the superiority parameters representing integrity of the specified data in each of the data servers.

In an embodiment, the candidate data server list records every data server which stores the specified data.

In an embodiment, when the candidate data server list records p data servers of the m data servers wherein p is a positive integer greater than 1, the client terminal reads parts of the specified data from the p data servers, respectively, or reads the specified data from one of the p data servers.

### BRIEF DESCRIPTION OF THE DRAWINGS

The advantages of the present disclosure will become more readily apparent to those ordinarily skilled in the art after reviewing the following detailed description and accompanying drawings, in which:

FIG. 1 is a block diagram illustrating a data source system having duplicate data sources according to an embodiment of the present disclosure; and

FIG. 2 is a flowchart illustrating a data reading method of the data source system according to an embodiment of the present disclosure.

### DETAILED DESCRIPTION OF PREFERRED EMBODIMENTS

The present disclosure will now be described more specifically with reference to the following embodiments. It is to be noted that the following descriptions of preferred embodiments of this invention are presented herein for purpose of illustration and description only. It is not intended to be exhaustive or to be limited to the precise form disclosed.

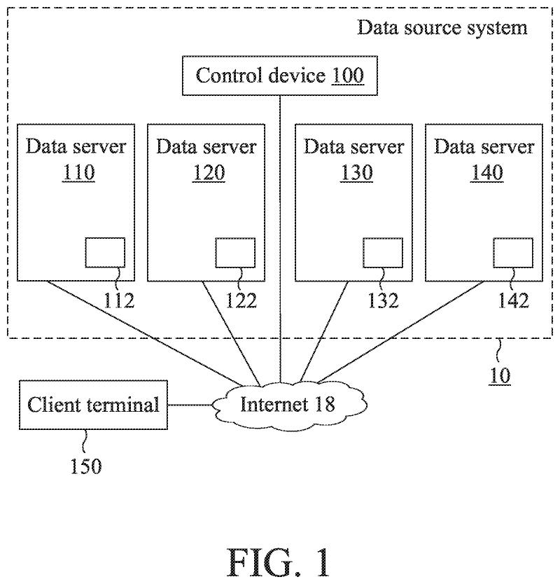

Please refer to FIG. 1, which is a block diagram illustrating a data source system having duplicate data sources according to an embodiment of the present disclosure. In the embodiment, the data source system 10 includes a control device 100 and four data servers 110, 120, 130 and 140, each of which includes a storage area for storing data. As shown in FIG. 1, the data server 110 includes a storage area 112, the data server 120 includes a storage area 122, the data server 130 includes a storage area 132, and the data server 140 includes a storage area 142. Each of these storage areas could be a part of a storage device, exactly one storage device or a combination of multiple storage devices. It is to be noted that the number of data servers in one data source system is not limited to this embodiment.

In the data source system 10, the control device 100 controls the data transmission from/to the data servers 110, 120, 130 and 140. The control instruction or the data could be transmitted between the control device 100 and the data servers 110, 120, 130 and 140 through any network (e.g. internet 18) adapted to transmit electronic signals. Similarly, the signal could be transmitted between the client terminal 150 and the control device 100/data servers 110, 120, 130 and 140 through the internet 18.

When the client terminal 150 is going to write data into the data source system 10, specified data are transmitted from the client terminal 150 to the control device 100. The control device 100 determines the data storage location according to the loading of the data servers 110, 120, 130 and 140. The control device 100 could determine to write the data into a single data server or divide the data into data sections to be stored in different data servers. The data server or data servers designated and involved in the determination step are called primary data server(s) corresponding to the data. Furthermore, the control device 100 duplicates the data or data sections and writes the backup copy into other data servers. The data servers for the backup copy are called backup data server corresponding to the data. In the specification, the term “data” may represent specific combination of files.

For example, the control device 100 puts complete data D1 in the data server 110, and designates the data servers 130 and 140 to store a backup copy of the data D1. At this time, the data server 110 is the primary data server corresponding to the data D1, and the data servers 130 and 140 are the backup data servers corresponding to the data D1.

As another example, the control device 100 divides the data D1 into data D2 and D3, puts a primary copy of the data D2 in the data server 120, puts a primary copy of the data D3 in the data server 140, puts a backup copy of the data D2 in the data servers 110 and 140, and puts the backup copy of the data D3 in the data servers 120 and 130. At this time, according to the above definition, the primary data server corresponding to the data D2 is the data server 120, and the backup data servers corresponding to the data D2 are the data servers 110 and 140. Similarly, the primary data server corresponding to the data D3 is the data server 140, and the backup data servers corresponding to the data D3 are the data servers 120 and 130.

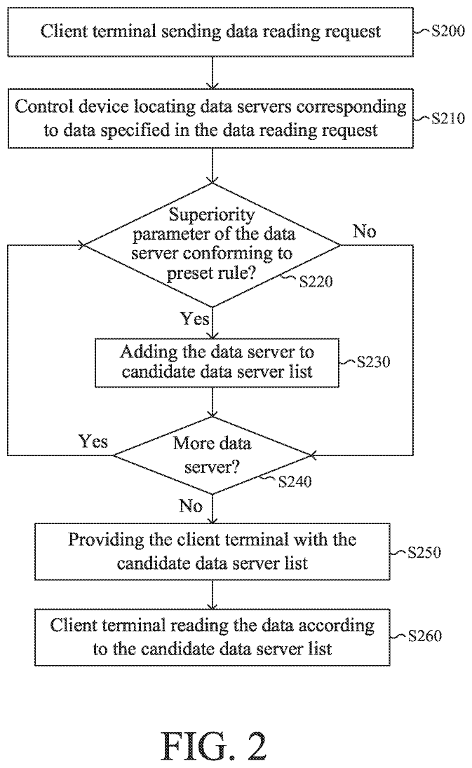

Please further refer to FIG. 2, which is a flowchart illustrating a data reading method of the data source system according to an embodiment of the present disclosure. At first, the client terminal 150 sends a data reading request to the control device 100 (step S200). Upon receiving the data reading request, the control device 100 locates all of the primary data server and the backup data servers corresponding to the data specified in the data reading request (step S210). Subsequently, the control device 100 judges whether a superiority parameter related to each located data server conforms to a preset rule (step S220). If the superiority parameter conforms to the preset rule, the corresponding data server is added to a candidate data server list (step S230). The judging step is repetitively performed for all located data servers (step S240). Then, the candidate data server list is transmitted to the client terminal 150 (step S250). Accordingly, the client terminal 150 reads the data from a selected data server according to the candidate data server list (step S260).

In an embodiment, the superiority parameter is defined as the service area of the located data server. If the client terminal 150 is positioned within the service area of the located data server, the superiority parameter related to the located data server conforms to the preset rule. In the above embodiment concerning the data D1 wherein the primary data server is the data server 110 and the backup data servers are the data servers 130 and 140, the control device 100 sequentially judges whether the service areas of the two backup data servers and one primary data server cover the current position of the client terminal 150. If the service area of one of the data servers covers the current position of the client terminal 150, the corresponding data server is added to the candidate data server list. A particular case that the client terminal 150 is not positioned in the service area of any located data server should be taken into consideration. Therefore, if the client terminal 150 is not positioned in the service area of any located backup data server, the located primary data server is directly added to the candidate data server list without checking whether the service area of the located primary data server covers the current position of the client terminal 150.

In another embodiment, the superiority parameter is defined as the integrity of the specified data stored in one located data server. Please refer to the above embodiment concerning the data D2 and D3 wherein the primary data server corresponding to the data D2 is the data server 120, the backup data servers corresponding to the data D2 are the data servers 110 and 140, the primary data server corresponding to the data D3 is the data server 140, and the backup data servers corresponding to the data D3 are the data servers 120 and 130. It is desired to read the data D2 and D3 from the same data server. Because the data server 120 is the primary data server corresponding to the data D2 and the backup data server corresponding to the data D3, the superiority parameter related to the data server 120 conforms to the preset rule. Similarly, because the data server 140 is the backup data server corresponding to the data D2 and the primary data server corresponding to the data D3, the superiority parameter related to the data server 140 also conforms to the preset rule. Therefore, the data servers 120 and 140 are added to the candidate data server list in the step S230. If the data are not completely stored in one data server, no matter in the form of the primary copy or the backup copy, the preset rule could be defined as the highest integrity of the specified data stored in one data server. In other words, the data server storing the most data has the highest priority. Alternatively, the service area of the data server as described above could be incorporated in the superiority parameter to provide the candidate data server list.

In another embodiment, all data servers related to the specified data are added to the candidate data server list, that is to say, the superiority parameter could be considered as the presence of the specified data in the data server. In this case, the steps of judging the superiority parameter and providing the candidate data server list (steps S220-240) are equivalent to the step of locating the data servers (step S210). Therefore, after the steps S200 and S210, the data servers located in the step S210 are directly added to the candidate data server list for use in the steps S250 and S260.

It is to be noted that if only one data server is recorded or proposed in the candidate data server list, the client terminal 150 can read the data from the proposed data server immediately. Otherwise, if at least two data servers are recorded or proposed in the candidate data server list, the client terminal 150 could select one or more data servers according to the data transmission rate. The analysis mechanism of the data transmission rate between two devices, e.g. based on transmission distance, transmission time or parallel access supportability, has been well-developed and could be applied to select the preferred data server(s). The known analysis mechanism is not particularly described herein.

In conclusion, the data reading method of a data source system having duplicate data sources of the present disclosure considers the better transmission path before informing the client terminal of the proposed data server(s) for providing the data. Alternatively, the candidate data server list provided by the data source system could include all data servers which store therein the specified data. The client terminal could select one or more data servers with higher data transmission rate to acquire the specified data wherein the data transmission rate may be obtained by any known analysis mechanism e.g. based on transmission distance, transmission time or parallel access supportability. Therefore, the data reading method of the present disclosure can reduce the overall data transmission time to improve the access efficiency.

While the disclosure has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A data reading method of a data source system having duplicate data sources, the data source system comprising m data servers wherein m is a positive integer, the data source system storing specified data by storing a primary copy of the specified data in a primary data server of the m data servers and storing a backup copy of the specified data in each of at least one backup data server of the m data servers other than the primary data server, the data reading method comprising steps of:
receiving a data reading request of the specified data from a client terminal;
obtaining a superiority parameter related to each of the primary data server and the at least one backup data server;
providing a candidate data server list according to the obtained superiority parameters, the candidate data server list recording at least one of the primary data server and the at least one backup data server; and
the client terminal receiving the candidate data server list and reading the specified data from the primary data server or the at least one backup data server recorded in the candidate data server list.

2. The data reading method according to claim 1, wherein the steps of obtaining the superiority parameters and providing the candidate data server list according to the obtained superiority parameters comprises steps of:
judging whether the client terminal is positioned within a service area of any one of the at least one backup data server;
when the client terminal is positioned within the service area of one of the at least one backup data server, adding the one backup data server to the candidate data server list; and
when the client terminal is not positioned within the service area of any one of the at least one backup data server, adding the primary data server to the candidate data server list.

3. The data reading method according to claim 2, wherein when the candidate data server list records p data servers of the m data servers wherein p is a positive integer greater than 1, the client terminal reads the specified data from the p data servers.

4. The data reading method according to claim 1, wherein the candidate data server list is determined according to the superiority parameters representing integrity of the specified data in each of the m data servers.

5. The data reading method according to claim 4, wherein when the candidate data server list records p data servers of the m data servers wherein p is a positive integer greater than 1, the client terminal reads the specified data from the p data servers.

6. The data reading method according to claim 1, wherein the candidate data server list records every data server which stores the specified data.

7. The data reading method according to claim 6, wherein when the candidate data server list records p data servers of the m data servers wherein p is a positive integer, the client terminal reads the specified data from one of the p data servers.
